(19) United States
(12) Patent Application Publication
(10) Pub. No.: US 2013/0145097 A1
(43) Pub. Date: Jun. 6, 2013

(54) Selective Access of a Store Buffer Based on Cache State

(71) Applicants: Ajay Anant Ingle, Austin, TX (US); Lucian Codrescu, Austin, TX (US)

(72) Inventors: Ajay Anant Ingle, Austin, TX (US); Lucian Codrescu, Austin, TX (US)

(73) Assignee: QUALCOMM INCORPORATED, San Diego, CA (US)

(21) Appl. No.: 13/310,955

(22) Filed: Dec. 5, 2011

(51) Int. Cl. G06F 12/08

(52) U.S. Cl. 711/127; 711/130; 711/128; 711/E12.018; 711/E12.038

(57) ABSTRACT

An apparatus includes a cache memory that includes a state array configured to store state information. The state information includes a state that indicates updated corresponding to a particular address of the cache memory is not stored in the cache memory but is available from at least one of multiple sources external to the cache memory, where at least one of the multiple sources is a store buffer.

### FIELD

The present disclosure is generally related to store buffers and management thereof.

### Description of Related Art

Advances in technology have resulted in smaller and more powerful computing devices. For example, there currently exist a variety of portable personal computing devices, including wireless computing devices, such as portable wireless telephones, personal digital assistants (PDAs), and paging devices that are small, lightweight, and easily carried by users. More specifically, portable wireless telephones, such as cellular telephones and internet protocol (IP) telephones, can communicate voice and data packets over wireless networks. Further, many such wireless telephones include other types of devices that are incorporated therein. For example, a wireless telephone can also include a digital still camera, a digital video camera, a digital recorder, and an audio file player. Also, such wireless telephones can process executable instructions, including software applications, such as a web browser application, that can be used to access the Internet. As such, these wireless telephones can include significant computing capabilities.

As the computing capabilities of electronic devices such as wireless telephones increase, memory accesses (to retrieve stored data) typically also increase. Thus, memory caches are used to store data so that access to the data can be provided faster than for data stored in main memory. If requested data is stored in the cache memory (i.e., results in a cache hit), the request for the data can be serviced faster by accessing the cache memory than by accessing the data from main memory (i.e., in response to a cache miss).

Store buffers may be used to improve the performance of memory caches. A store buffer may be used to temporarily store modified data when the cache memory is not available to accept the modified data. For example, a cache memory may be unavailable to accept the modified data if there is a cache bank conflict (i.e., the cache bank is unavailable for load/store or store/store operations) or when there is a single port and only one read or write operation may be performed at a time. Sometimes, the data may not be ready to be stored in the cache memory (e.g., the data is not available when the port is available). In the above situations, the modified data may be temporarily stored in the store buffer until the modified data can be stored in the cache memory.

When a store buffer stores modified data corresponding to a particular address, subsequent loads (e.g., read operations) to the same or overlapping address should return the modified data from the store buffer, not the outdated data from the cache. Conventional techniques address this issue by comparing the address in a load instruction to each of the addresses of the store buffer to determine if modified data is stored in the store buffer. If a match is found, the data in the store buffer is drained (e.g., the outdated data in the cache memory is overwritten with the modified data from the store buffer). This technique may require multiple comparators and processing time to compare an address of the load instruction to each of the addresses of the store buffer, resulting in an increased area of store buffer circuitry and increased power consumption.

### SUMMARY

A method of using state information in a cache memory to manage access to a store buffer is disclosed. Each cache line in a cache memory may have state information indicating that the cache line is: Invalid ‘I’ (i.e., the cache has no data); Clean ‘C’ (i.e., data in the cache matches data in main memory (unmodified)); Miss Data Pending ‘R’ (i.e., data is not in the cache and needs to be fetched from main memory due to a cache miss), or Modified ‘M’ (i.e., data in the cache does not match data in the main memory because the data in the cache has been modified). The state information may be used to determine when to selectively access and drain a store buffer coupled to the cache memory.

To illustrate, the disclosed method may modify or extend the ‘R’ state information to indicate that updated data corresponding to a particular address of a cache memory may be available from one of multiple sources (e.g., including the store buffer) external to the cache memory, not just that the data may be available from the main memory. Logic coupled to the store buffer and to the cache memory may compare an address of requested data with the addresses of the store buffer upon detecting that the address has an ‘R’ bit that is asserted in the cache memory. Thus, comparison of the requested address to the addresses of the store buffer may be performed only after detecting the ‘R’ bit is asserted in the cache line, thereby reducing power consumption and cost associated with the store buffer.

In a particular embodiment, an apparatus includes a cache memory that includes a state array configured to store state information. The state information includes a state that indicates updated data corresponding to a particular address of the cache memory is not stored in the cache memory but is available from at least one of multiple sources external to the cache memory. At least one of the multiple sources is a store buffer.

In another particular embodiment, a method includes storing state information at a state array of a cache memory. The state information includes a state that indicates updated data corresponding to a particular address of the cache memory is not stored in the cache memory but is available from at least one of multiple sources external to the cache memory. At least one of the multiple sources is a store buffer.

In another particular embodiment, an apparatus includes means for caching data and means for storing state information associated with the means for caching data. The state information includes a state that indicates updated data corresponding to a particular address of the means for caching data is not stored in the means for caching data but is available from at least one of multiple sources external to the means for caching data. At least one of the multiple sources is a store buffer.

In another particular embodiment, a non-transitory computer-readable medium includes program code that, when executed by a processor, causes the processor to store state information at a state array of a cache memory. The state information includes a state that indicates updated data corresponding to a particular address of the cache memory is not stored in the cache memory but is available from at least one of multiple sources external to the cache memory, where at least one of the multiple sources is a store buffer.

One particular advantage provided by at least one of the disclosed embodiments is reduction in cost and power consumption associated with a store buffer by selectively accessing the store buffer based on cache state instead of accessing the store buffer during each load operation.

Other aspects, advantages, and features of the present disclosure will become apparent after review of the entire application, including the following sections: Brief Description of the Drawings, Detailed Description, and the Claims.

### BRIEF DESCRIPTION OF THE DRAWINGS

FIG. 1 is a diagram of a particular embodiment of a system that includes a store buffer and control logic to manage the store buffer;

FIG. 2 is a diagram of a particular example of operation at the system of FIG. 1;

FIG. 3 is a flow chart of a particular embodiment of a method of managing a store buffer;

FIG. 4 is a block diagram of another particular embodiment of a system that includes a store buffer and control logic to manage the store buffer; and

FIG. 5 is a block diagram of a wireless device having a processor that includes a store buffer and control logic to manage the store buffer.

### DETAILED DESCRIPTION

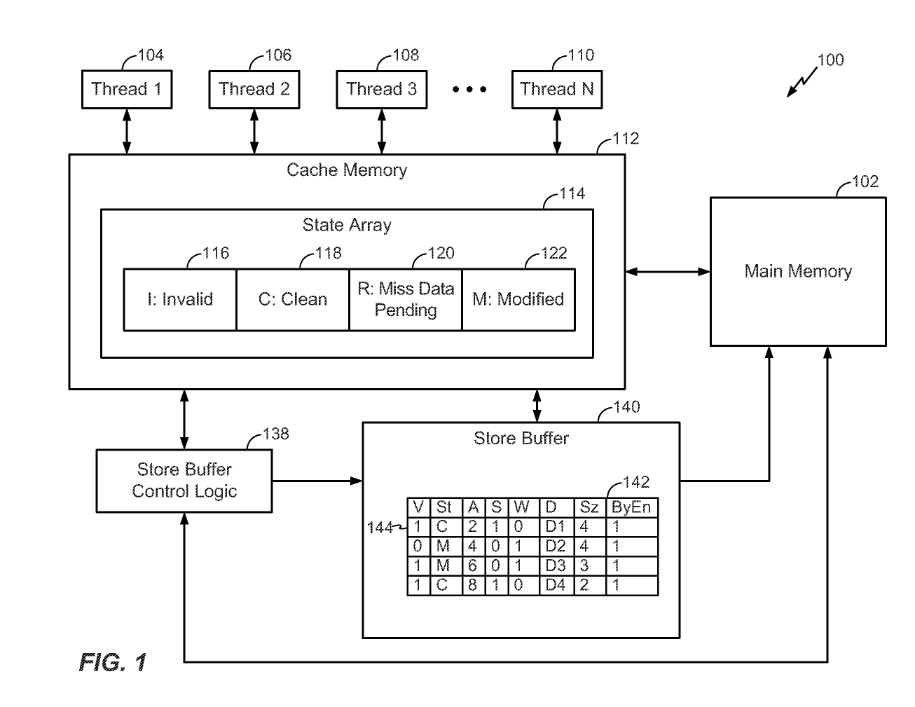

Referring to FIG. 1, a particular illustrative embodiment of an apparatus 100 is shown. The apparatus 100 includes a cache memory 112 and a main memory 102. In a particular embodiment, the main memory 102 may be a random access memory (RAM). The apparatus 100 also includes a store buffer 140 configured to temporarily store modified data before the modified data is written to the cache memory 112. Store buffer control logic 138 may be coupled to the store buffer 140.

The store buffer 140 may include a plurality of entries 142 and each entry may include valid bit information (designated ‘V’), state information (e.g., ‘C’ or ‘M’) indicating when to write back to the cache memory 112 (designated ‘St’), address information (designated ‘A’), set information (designated ‘S’), way information (designated ‘W’), data information (designated ‘D’), store size information (designated ‘Sz’), and byte enable information (designated ‘ByEn’). For example, an entry 144 may include a valid bit set to ‘1,’ a ‘C’ state (i.e., clean state), an address location ‘2,’ set is ‘1,’ way is ‘0,’ data is ‘D1,’ store size is ‘4,’ and the byte enable is set to ‘1.’ It should be noted that the store buffer may have fewer or more entries than shown in FIG. 1.

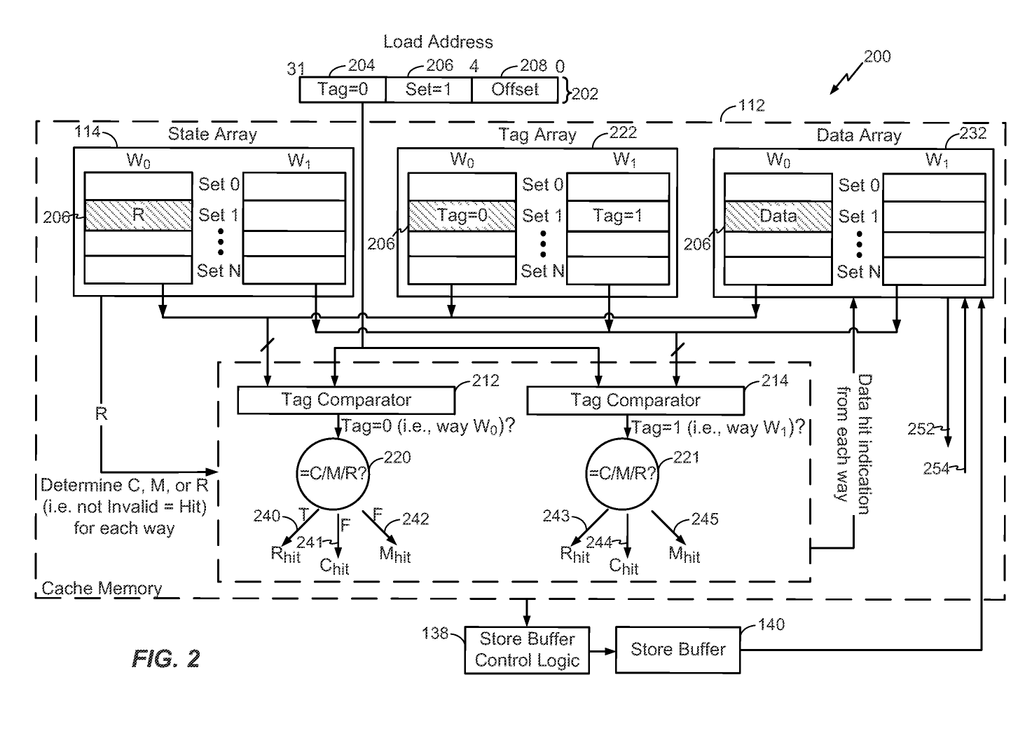

The cache memory 112 may be accessible to each of a plurality of threads. For example, the cache memory 112 may be accessible to a first thread 104, a second thread 106, a third thread 108, and other threads up to an N^{th} thread 110. The cache memory 112 may include a state array 114. Although FIG. 1 shows the state array 114 included in the cache memory 112, it should be noted that the cache memory 112 may be coupled to the state array 114, where the state array 114 is external to the cache memory 112 (e.g., as shown in FIG. 2). The state array 114 includes a plurality of entries, where each entry corresponds to a storage location in the cache memory 112. Each entry in the state array 114 may include a first value 116, a second value 118, a third value 120, and a fourth value 122.

In a particular illustrative embodiment, the first value 116 indicates invalid data (I), the second value 118 indicates clean data (C) (i.e., data that is unmodified and identical to corresponding data in the main memory 102), the third value 120 indicates miss data pending (R), and the fourth value 122 indicates modified data (M) (i.e., data that is not identical to corresponding data in the main memory 102). For example, the cache memory 112 may include an ‘R’ bit, an ‘I’ bit, a ‘C’ bit and an ‘M’ bit for each cache line, where one of the bits may be asserted to indicate a state of the cache line. As described herein, one of the potential values 116-122 of the state information stored in the state array 114 (e.g., the ‘R’ value 120) may be used to indicate updated data (e.g., data requested by a load operation) corresponding to a particular address of the cache memory 112 is not stored in the cache memory 112 but is available from at least one of multiple sources external to the cache memory 112. In a particular embodiment, the state information may also be used to indicate that tag information and state information corresponding to the updated data are stored in the cache memory. In another particular embodiment, the store buffer 140 is a source that is external to the cache memory 112 and the store buffer 140 may store the requested data. Another of the multiple sources external to the cache memory 112 may be the main memory 102. For example, the store buffer 140 may be a source that is external the cache memory 112 and the main memory 102 may be another one of the multiple sources external to the cache memory 112, as shown in FIG. 1. Thus, in FIG. 1, the cache memory 112 may receive data either from the main memory 102 or from the store buffer 140.

In a particular illustrative embodiment, the store buffer control logic 138 may be configured to perform an address compare to determine at least one state based on the information stored in the state array 114. The store buffer control logic 138 may also be configured, upon detecting that the at least one state is the state that indicates that updated data corresponding to the particular address is not stored in the cache memory 112 (i.e., when the corresponding state from the state array 114 is ‘R’), to selectively drain and/or retrieve data from the store buffer 140.

For example, in a first implementation, the store buffer control logic 138 may drain the store buffer 140 (e.g., output all the data values stored at the store buffer 140 to the cache memory 112) when the state information matches the ‘R’ value (e.g., the ‘R’ bit is asserted). In a second implementation, the store buffer control logic 138 may selectively retrieve data from the store buffer 140 based on a partial address comparison. For example, if the requested address includes a tag (i.e., way), a set address, and an offset, the store buffer control logic 138 may retrieve data from the store buffer 140 when the tag of the requested address matches a tag of the state information from the state array 114. In a third implementation, the store buffer control logic 138 may selectively retrieve data from the store buffer 140 when both the tags and the set addresses match. In a fourth implementation, the store buffer control logic 138 may selectively retrieve data from the store buffer 140 based on a full address comparison (i.e., when the tags, the set addresses, and the offsets match). Thus, the store buffer control logic 138 may perform a partial address comparison or a full address comparison in different implementations. Various other implementations may also be possible. Which particular implementation is used may depend on factors such as cache size, cache access frequency, timing considerations, and performance and power tradeoffs.

In a particular embodiment, the cache memory 112 may support multiple memory access operations in a single very long instruction word (VLIW) packet. For example, two or more load operations and/or store operations may access the cache memory 112 during a single execution cycle. Thus, two or more of the threads 104-110 may access the cache memory 112 in parallel. Moreover, multiple threads may access the same address (e.g., same location in the cache memory 112).

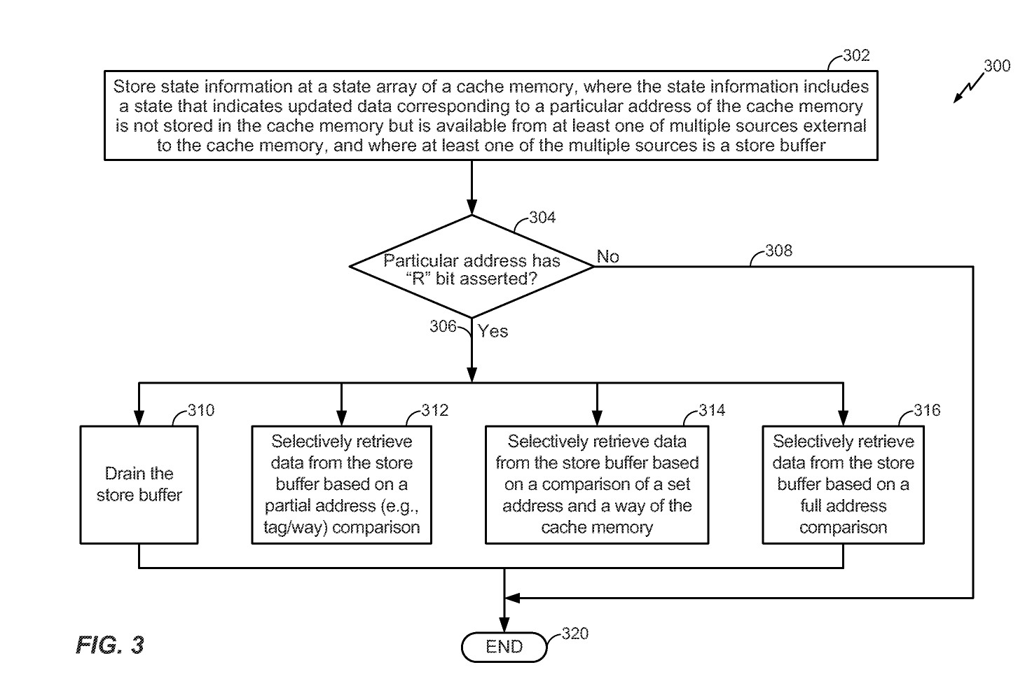

During operation, the first thread 104 may execute a store operation that modifies data having a particular address, where the data was previously cached at the cache memory 112. If the cache memory 112 cannot be updated with the modified data (e.g., because another thread 106-110 is accessing the cache or another slot needs access to the same cache bank), the modified data may be stored in the store buffer 140 and a corresponding state in the state array 114 may be set to ‘R’ (e.g., the ‘R’ bit may be asserted in the state array 114). Subsequently, the first thread 104 or another thread, such as the second thread 106, may execute a load operation on the particular address. Since the data in the cache memory 112 corresponding to the particular address has the ‘R’ bit asserted, the store buffer control logic 138 may determine whether or not to update the cache memory 112 with the modified data from the store buffer 140. For example, the determination may be based on a partial address comparison or a full address comparison. Particular examples of determining whether or not to retrieve data from a store buffer is further described with reference to FIGS. 2-3.

The apparatus 100 of FIG. 1 may thus use the ‘R’ state information polymorphically to provide useful information about the availability of data in the store buffer 140. Selectively accessing and retrieving data from the store buffer 140 in response to the ‘R’ bit being asserted in the state array 114 may reduce cost and power consumption associated with managing the store buffer 140. In addition, using the existing ‘R’ bit may enable implementing the disclosed techniques with fewer modifications to existing system than if a new state were introduced to indicate that updated data is available from a store buffer.

FIG. 2 illustrates a particular example of operation at the apparatus 100 of FIG. 1, and is generally designated 200. In the particular illustrative embodiment of FIG. 2, the cache memory 112 includes the state array 114, a tag array 222, a data array 232, tag comparators 212 and 214, and state comparators 220 and 221. The cache memory 112 may be a 2-way set associative cache memory (i.e., data from each location in main memory 102 may be cached in any one of 2 locations in the cache memory). It should be noted that although FIG. 2 illustrates a 2-way set associative cache memory, the described techniques may be implemented in a X-way set associative cache memory, where X is an integer greater than 0. Further, there is a tag comparator 212, 214 and a state comparator 220, 221 for each way W₀, W₁. For example, the tag comparator 212 and the state comparator 220 may be associated with way W₀ and the tag comparator 214 and the state comparator 221 may be associated with way W₁. Each of the state array 114, the tag array 222, and the data array 232 may include a plurality of sets (i.e., set 0, set 1 . . . set N) and each set may include a first way W₀ and a second way W₁. Each set of the plurality of sets 0-N corresponds to index positions (e.g., locations of cache lines) in each of the ways W₀ and W₁ of the cache memory 112 where data can be stored. For example, a particular data item “Data” may be stored in set 1 of the first way W₀ of the data array 232, as shown.

Entries in the state array 114 may store state information associated with data stored in the cache memory 112 (i.e., entries in the data array 232). For example, as illustrated in FIG. 2, the data item “Data” in way W₀ indicates that an ‘R’ bit is asserted (i.e., miss data pending). The states of other data items (not shown) in the data array 232 may be the ‘R’ state, the ‘C’ state (i.e., the particular data is unmodified and identical to corresponding data in the main memory 102), the ‘M’ state (i.e., the particular data is not identical to corresponding data in the main memory 102), or the ‘I’ state (i.e., the particular data is invalid). In a particular embodiment, the ‘R’ state may indicate that the particular data (i.e., updated data) is not stored in the cache memory 112 but is available from at least one of multiple sources external to the cache memory 112, where one of the multiple sources includes the store buffer 140 of FIG. 1. In another particular embodiment, the ‘R’ state may also indicate that tag information and state information corresponding to the updated data are stored in the cache memory 112.

During operation, a thread (e.g., one of the plurality of threads 104-110 of FIG. 1) accessing the cache memory 112 may execute a load operation on a particular address corresponding to particular data. The particular data may be stored in the cache memory 112 (e.g., by a store operation previously executed by the same thread 104 or another one of the plurality of threads 106-110). The load instruction may specify a load address 202 including a tag portion 204, a set portion 206, and an offset portion 208. For example, the load address 202 may be a 32-bit address, where the offset portion 208 may be located in bits 0-4 of the load address (i.e., the 4 least significant bits), the tag portion 204 may be located in the most significant bit position of the load address 202, and the set portion 206 may be located between the offset portion 208 and the tag portion 204. In the embodiment of FIG. 2, the load address 202 corresponds to the data item “Data.” Thus, the tag 204 of the load address is ‘0’ and the set 206 of the load address is ‘1.’

The tag comparators 212, 214 of the cache memory 112 may compare the tag portion 204 (i.e., tag=0) of the load address 202 to the tags of the state array 114, the tag array 222, and the data array 232 to determine a way in the cache memory 112 corresponding to the load address 202. For example, the tag comparator 212 associated with way W₀ may output a ‘1’ (i.e., True) because the tag portion 204 of the load address 202 is ‘0’ and the tag comparator 214 associated with way W₁ may output a ‘0’ (i.e., False) because the tag portion 204 of the load address 202 is not ‘1.’ The set portion 206 of the load address 202 is used to select particular contents of the state array 114, the tag array 222, and the data array 232 to be looked up. For example, because the set portion 206 of the load address is ‘1,’ set ‘1’ of way W₀ (i.e., index position ‘1’ of W₀) of the state array 114, the tag array 222, and the data array 232 may be selected for retrieval.

Next, an output of the state array 114 may be input to each of the state comparators 220 and 221 to determine a hit in the state array 114. To illustrate, the state information including the asserted ‘R’ bit in way W₀ of the state array 114 may be output to each of the state comparators 220 and 221. At the state comparator 220, it is determined that the output of the state array 114 indicates one of “C/M/R” (i.e., “=C/M/R?” is True) and the state comparator 220 may output a ‘1’ (i.e., True). Similarly, at the state comparator 221, it is determined that the output of the state array 114 indicates one of “C/M/R” (i.e., “=C/M/R?” is True) and the state comparator 221 may output a ‘1’ (i.e., True). In a particular embodiment, the output of the tag comparators 212, 214 is ANDed with the output of the state comparators 220, 221 to indicate a ‘hit’ to the data array 232. To illustrate, the output ‘1’ from the tag comparator 212 may be ANDed with the output ‘1’ of the state comparator to generate a hit (i.e., ‘1’) at way W₀ (i.e., 1 AND 1=1). The output ‘0’ from the tag comparator 214 may be ANDed with the output ‘1’ of the state comparator 221 to generate a no-hit (i.e., ‘0’) at way W₁ (i.e., 0 AND 1=0). A data hit (or no-hit) indication from each way W₀ and W₁ may be provided as input to the data array 232 (i.e., an output of each AND operation may be provided as input to the data array 232). The data array 232 may also include a Data Write input 254 for writing data (e.g., representative “Data”) to the data array 232 and a Data Read output 252 for reading data from the data array 232. For example, representative “Data” may be selected (i.e., read) from the data array 232 based on the set portion 206 of the load address 202 and a corresponding way (i.e., way W₀) of the determined data hit.

In a particular embodiment, the state comparators 220, 221 may also be configured to determine if the hit is a Cₕᵢₜ, an Mₕᵢₜ, or an Rₕᵢₜ. For example, the state comparator 220 may identify an ‘R hit’ based on state information stored in set ‘1’ of way W₀ in the state array 114 and assert the Rₕᵢₜ 240 output. The Cₕᵢₜ 241 and the Mₕᵢₜ 242 may not be asserted, as shown. The Rₕᵢₜ 240, when asserted, may indicate that the particular data specified by the load address 202 is not stored in the cache memory 112 but is available from at least one of multiple sources external to the cache memory 112 (e.g., including the store buffer 140).

Upon determining that the hit is the Rₕᵢₜ 240, the cache memory 112 may send this information to the store buffer control logic 138. The Rₕᵢₜ 240 determination by the cache memory 112 may activate the store buffer control logic 138 (and the store buffer 140), and the store buffer control logic 138 may selectively drain and/or retrieve the particular data from the store buffer 140. For example, the store buffer control logic 138 may implement one or more of the processes described with reference to FIG. 3 to selectively drain and/or retrieve the particular data from the store buffer 140. An output of the store buffer 140 may be input to the data array 232. For example, the particular data drained/retrieved from the store buffer 140 may be input to the data array 232.

Referring to FIG. 3, a particular illustrative embodiment of a method of managing a store buffer is disclosed and generally designated 300. In an illustrative embodiment, the method 300 may be performed at the apparatus 100 of FIG. 1 and may be illustrated with reference to FIG. 2.

The method 300 may include storing state information at a state array of a cache memory, at 302. The state information may include a state that indicates updated data corresponding to a particular address of the cache memory is not stored in the cache memory but is available from at least one of multiple sources external to the cache memory. At least one of the multiple sources may be a store buffer. For example, the state information may be stored in the state array 114 of FIGS. 1-2 and may have four potential values: invalid (I) 116, clean (C) 118, miss data pending (R) 120, and modified (M) 122. The state array 114 may be included in the cache memory 112 (e.g., as in FIGS. 1-2) or may be external to and coupled to the cache memory 112.

The method 300 also includes determining whether the particular address has an ‘R’ bit that is asserted, at 304. In a particular embodiment, the determination may involve comparators in the cache memory determining whether a cache hit and a Rₕᵢₜ occur, as described with reference to FIG. 2. When the particular address does not indicate that the ‘R’ bit is asserted, the method 300 proceeds, at 308, and ends, at 320. For example, if the state comparator 220 of the cache memory 112 does not determine a Rₕᵢₜ 230 at the state array 114 corresponding to the particular load address, but determines either a Cₕᵢₜ 232 or a Mₕᵢₜ 234, then the method 300 may end because the data corresponding to the load address 202 is clean or has been modified, and thus need not be retrieved from any source external to the cache memory 112.

When the particular address has the ‘R’ bit asserted, the method 300 may proceed, at 306, and determine whether to access and retrieve data from (e.g., drain) the store buffer. For example, in a first implementation, the method 300 may drain the store buffer, at 310. Thus, in the first implementation, the store buffer may be drained each time there is a Rₕᵢₜ 230. In a second implementation, the method 300 may selectively retrieve data from the store buffer based on a partial address (e.g., tag/way) comparison, at 312. Thus, in the second implementation, the store buffer may be accessed and/or drained fewer times than in the first implementation.

Alternatively, in a third implementation, the method 300 may selectively retrieve data from the store buffer based on a comparison of both a set address and a way of the cache memory, at 314. Thus, the third implementation may produce fewer drains of the store buffer than either the first implementation or the second implementation. In a fourth implementation, the method 300 may include selectively retrieving data from the store buffer based on a full address comparison, at 316. To illustrate, the store buffer control logic 138 may compare the entire load address 202 when the ‘R’ bit is asserted, and if the full addresses match, the store buffer control logic 138 may retrieve the data from the store buffer 140. Thus, the fourth implementation may result in fewer data retrievals from the store buffer than the first, second, or third implementations. However, as more bits of the load address 202 are compared, more comparators and processing may be involved. Accordingly, the store buffer control logic 138 may perform a partial address comparison or a full address comparison in different implementations. Which of the four implementations (e.g., method steps 310-316) is selected may depend on design factors such as cache size, cache access frequency, and timing considerations.

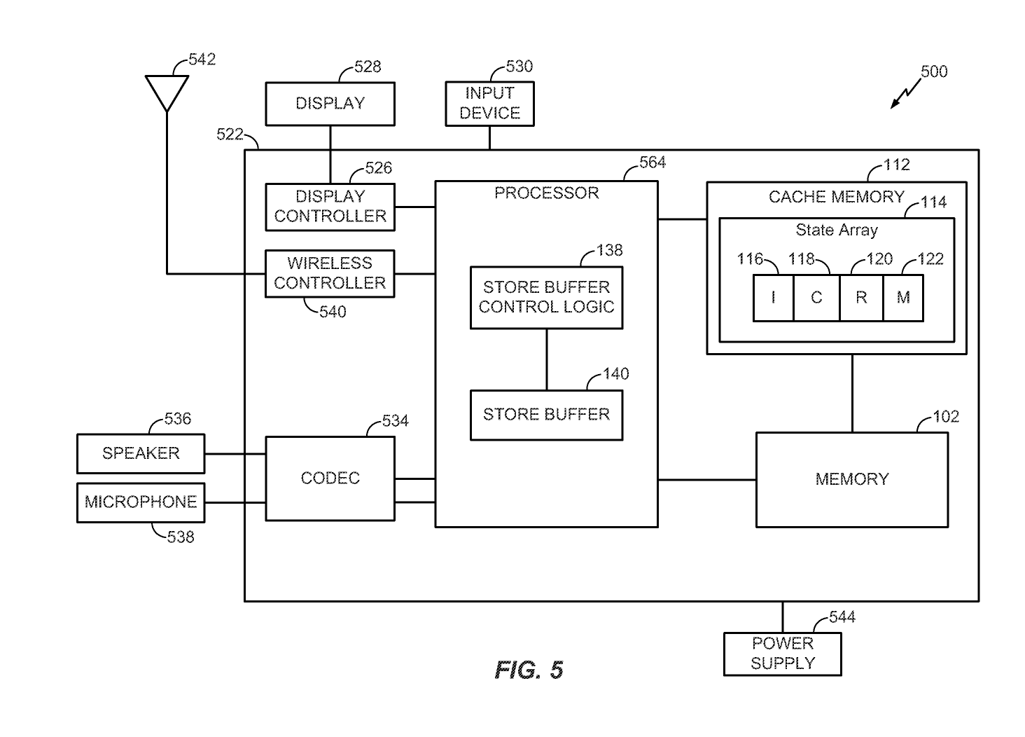

It should be noted that the method 300 of FIG. 3 may be implemented by a field-programmable gate array (FPGA) device, an application-specific integrated circuit (ASIC), a processing unit such as a central processing unit (CPU), a digital signal processor (DSP), a controller, another hardware device, firmware, or any combination thereof As an example, the method 300 of FIG. 3 can be performed by a processor or component thereof that executes program code or instructions, as described with respect to FIG. 5.

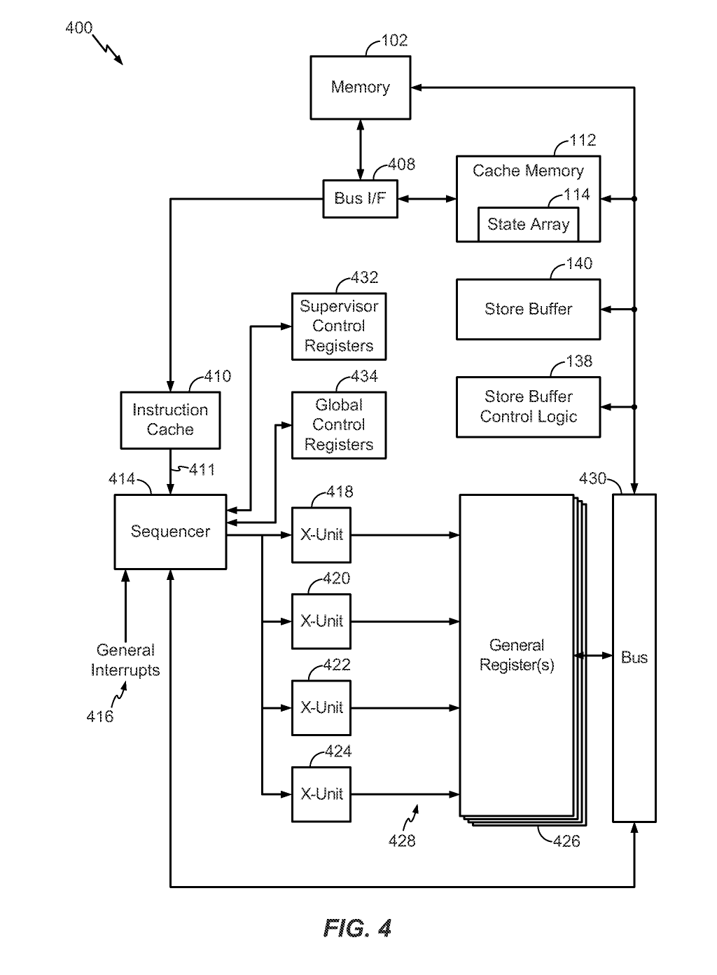

Referring to FIG. 4, a particular illustrative embodiment of a system including a store buffer 140 and store buffer control logic 138 to manage the store buffer 140 is disclosed and generally designated 400. The system 400 includes a memory 102 that may be coupled to a cache memory 112 via a bus interface 408. The memory 102 may also be coupled to the store buffer 140 and to the store buffer control logic 138, as shown. In a particular embodiment, all or a portion of the system 400 may be integrated into a processor. Alternately, the memory 102 may be external to the processor.

The cache memory 112 may include a state array 114, a tag array (not shown), and a data array (not shown). In another embodiment, the state array 114 may be external to and coupled to the cache memory 112. The state array 114 may include a plurality of entries (i.e., state information), where each entry corresponds to a storage location in the cache memory 112. As described with reference to FIGS. 1-3, when a particular address indicates that the ‘R’ bit is asserted, this may indicate that updated data corresponding to the particular address is not stored in the cache memory 112 but is available from at least one of multiple sources external to the cache memory (e.g., from the store buffer 140 or from the memory 102). Thus, in response to determining that the ‘R’ bit is asserted, data may be retrieved from either the memory 102 or the store buffer 140.

The store buffer control logic 138 may be configured to manage when and how often the store buffer 140 is accessed and data is retrieved from the store buffer 140. In particular, comparators in the cache memory 112 may be configured to perform an address compare to determine at least one state (i.e., ‘I,’ ‘C,’ ‘R,’ or ‘M’) based on the information stored in the state array 114. Upon detecting that the at least one state is the ‘R’ state at the cache memory 112, the store buffer control logic 138 may be activated to selectively drain and/or retrieve data from the store buffer 140. For example, the store buffer control logic 138 may drain the store buffer 140 each time the ‘R’ state is detected (e.g., the ‘R’ bit is asserted), may drain the store buffer 140 based on a partial address comparison, or may drain the store buffer based on a full address comparison.

An instruction cache 410 may also be coupled to the memory 102 via the bus interface 408. The instruction cache 410 may be coupled to a sequencer 414 via a bus 411. The sequencer 414 may receive general interrupts 416, which may be retrieved from an interrupt register (not shown). In a particular embodiment, the instruction cache 410 may be coupled to the sequencer 414 via a plurality of current instruction registers (not shown), which may be coupled to the bus 411 and associated with particular threads (e.g., hardware threads) of the processor 400. In a particular embodiment, the processor 400 may be an interleaved multi-threaded processor and/or simultaneous multi-threaded processor including six (6) threads.

In a particular embodiment, the bus 411 may be a one-hundred and twenty-eight bit (128-bit) bus and the sequencer 414 may be configured to retrieve instructions from the memory 102 via instruction packets having a length of thirty-two (32) bits each. The bus 411 may be coupled to a first execution unit 418, a second execution unit 420, a third execution unit 422, and a fourth execution unit 424. It should be noted that there may be fewer or more than four execution units. Each execution unit 418, 420, 422, and 424 may be coupled to a general register file 426 via a second bus 428. The general register file 426 may also be coupled to the sequencer 414, the store buffer control logic 138, the store buffer 140, the cache memory 112, and the memory 102 via a third bus 430. In a particular embodiment, one or more of the execution units 418-424 may be load/store units.

The system 400 may also include supervisor control registers 432 and global control registers 436 to store bits that may be accessed by control logic within the sequencer 414 to determine whether to accept interrupts (e.g., the general interrupts 416) and to control execution of instructions.

Referring to FIG. 5, a block diagram of a particular illustrative embodiment of a wireless device that includes a processor having a store buffer and store buffer control logic to manage the store buffer is depicted and generally designated 500. The device 500 includes a processor 564 coupled to a cache memory 112 and to a memory 102. The processor 564 may include store buffer control logic 138 and a store buffer 140. The cache memory 112 may include a state array 114, where the state array 114 includes a plurality of entries, each entry having an invalid (I) value 116, a clean (C) value 118, a miss data pending (R) value 120, or a modified (M) value 122. The ‘R’ value 120 may indicate that updated data at a particular address of the cache memory 112 is not stored in the cache memory 112 but is available from at least one of multiple sources external to the cache memory 112. One of the multiple sources may be the store buffer 140. The store buffer control logic 138 may be configured to manage the store buffer 140 by performing an address compare to determine at least one state (i.e., ‘I,’ ‘C,’ ‘R,’ or ‘M’) based on the information stored in the state array 114. Upon detecting the ‘R’ state 120 (e.g., the ‘R’ bit is asserted) in the state array 114, the store buffer control logic 138 may selectively retrieve data from the store buffer 140.

FIG. 5 also shows a display controller 526 that is coupled to the processor 564 and to a display 528. A coder/decoder (CODEC) 534 can also be coupled to the processor 564. A speaker 536 and a microphone 538 can be coupled to the CODEC 534.

FIG. 5 also indicates that a wireless controller 540 can be coupled to the processor 564 and to a wireless antenna 542. In a particular embodiment, the processor 564, the display controller 526, the memory 102, the CODEC 534, and the wireless controller 540 are included in a system-in-package or system-on-chip device 522. In a particular embodiment, an input device 530 and a power supply 544 are coupled to the system-on-chip device 522. Moreover, in a particular embodiment, as illustrated in FIG. 5, the display 528, the input device 530, the speaker 536, the microphone 538, the wireless antenna 542, and the power supply 544 are external to the system-on-chip device 522. However, each of the display 528, the input device 530, the speaker 536, the microphone 538, the wireless antenna 542, and the power supply 544 can be coupled to a component of the system-on-chip device 522, such as an interface or a controller.

It should be noted that although FIG. 5 depicts a wireless communications device, the processor 564 and the memory 102 may also be integrated into other electronic devices, such as a set top box, a music player, a video player, an entertainment unit, a navigation device, a personal digital assistant (PDA), a fixed location data unit, or a computer.

In conjunction with the described embodiments, an apparatus is disclosed that includes means for caching data. For example, the means for caching data may include the cache memory 112 of FIGS. 1-2 and 4-5, one or more devices configured to cache data, or any combination thereof

The apparatus may also include means for storing state information associated with the means for caching. The state information includes a state that indicates data at a particular address is not stored in the means for caching but is available from at least one of multiple sources external to the means for caching. At least one of the multiple sources is a store buffer. For example, the means for storing state information may include the state array 114 of FIGS. 1-2 and 4-5, one or more devices configured to store state information, or any combination thereof.

Those of skill would further appreciate that the various illustrative logical blocks, configurations, modules, circuits, and algorithm steps described in connection with the embodiments disclosed herein may be implemented as electronic hardware, computer software, or combinations of both. Various illustrative components, blocks, configurations, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the embodiments disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of storage medium known in the art. An exemplary non-transitory (e.g. tangible) storage medium is coupled to the processor such that the processor can read information from, and write information to, the storage medium. In the alternative, the storage medium may be integral to the processor. The processor and the storage medium may reside in an application-specific integrated circuit (ASIC). The ASIC may reside in a computing device or a user terminal In the alternative, the processor and the storage medium may reside as discrete components in a computing device or user terminal.

The previous description of the disclosed embodiments is provided to enable a person skilled in the art to make or use the disclosed embodiments. Various modifications to these embodiments will be readily apparent to those skilled in the art, and the principles defined herein may be applied to other embodiments without departing from the scope of the disclosure. Thus, the present disclosure is not intended to be limited to the embodiments shown herein but is to be accorded the widest scope possible consistent with the principles and novel features as defined by the following claims.

What is claimed is:

1. An apparatus comprising:
a cache memory including a state array configured to store state information, wherein the state information includes a state that indicates updated data corresponding to a particular address of the cache memory is not stored in the cache memory but is available from at least one of multiple sources external to the cache memory and wherein at least one of the multiple sources is a store buffer.

2. The apparatus of claim 1, wherein the state further indicates that tag information and state information corresponding to the updated data are stored in the cache memory.

3. The apparatus of claim 1, wherein at least another of the multiple sources is a main memory.

4. The apparatus of claim 1, further comprising logic to perform an address compare to determine at least one state based on the state information stored in the state array.

5. The apparatus of claim 4, wherein the logic is further configured to drain the store buffer upon detecting that the at least one state is the state that indicates that updated data corresponding to the particular address of the cache memory is not stored in the cache memory.

6. The apparatus of claim 4, wherein the logic is further configured to selectively retrieve data from the store buffer based on a partial address comparison upon detecting that the at least one state is the state that indicates that updated data corresponding to the particular address of the cache memory is not stored in the cache memory.

7. The apparatus of claim 4, wherein the logic is further configured to selectively retrieve data from the store buffer based on a comparison of a set address and a way of the cache memory upon detecting that the at least one state is the state that indicates that updated data corresponding to the particular address of the cache memory is not stored in the cache memory.

8. The apparatus of claim 4, wherein the logic is further configured to selectively retrieve data from the store buffer based on a full address comparison upon detecting that the at least one state is the state that indicates that updated data corresponding to the particular address of the cache memory is not stored in the cache memory.

9. The apparatus of claim 1, wherein the state information includes a state that indicates that data at the particular address is invalid.

10. The apparatus of claim 1, wherein the state information includes a state that indicates that data at the particular address is clean and is identical to corresponding data stored in main memory.

11. The apparatus of claim 1, wherein the state information includes a state that indicates that data at the particular address has been modified and is different from corresponding data stored in main memory.

12. The apparatus of claim 1, wherein the cache memory supports multiple memory access operations in a very long instruction word (VLIW) packet.

13. The apparatus of claim 12, wherein two or more of the multiple access operations of the VLIW packet are performed in parallel.

14. The apparatus of claim 1, wherein the cache memory is accessible by a plurality of threads that share data stored in the cache memory in an interleaved multithreading processor, a simultaneous multithreading processor, or a combination thereof.

15. A method comprising:
storing state information at a state array of a cache memory, wherein the state information includes a state that indicates updated data corresponding to a particular address of the cache memory is not stored in the cache memory but is available from at least one of multiple sources external to the cache memory and wherein at least one of the multiple sources is a store buffer.

16. The method of claim 15, wherein the state further indicates that tag information and state information corresponding to the updated data are stored in the cache memory.

17. The method of claim 15, further comprising performing an address compare to determine at least one state based on the state information stored in the state array.

18. The method of claim 17, further comprising draining the store buffer upon detecting that the at least one state is the state that indicates that updated data corresponding to the particular address of the cache memory is not stored in the cache memory.

19. The method of claim 17, further comprising:
upon detecting that the at least one state is the state that indicates that updated data corresponding to the particular address of the cache memory is not stored in the cache memory, selectively retrieving data from the store buffer based on a partial address comparison.

20. The method of claim 17, further comprising:
upon detecting that the at least one state is the state that indicates that updated data corresponding to the particular address of the cache memory is not stored in the cache memory, selectively retrieving data from the store buffer based on a comparison of a set address and a way of the cache memory.

21. The method of claim 17, further comprising:
upon detecting that the at least one state is the state that indicates that updated data corresponding to the particular address of the cache memory is not stored in the cache memory, selectively retrieving data from the store buffer based on a full address comparison.

22. An apparatus comprising:
means for caching data; and
means for storing state information associated with the means for caching data, wherein the state information includes a state that indicates updated data corresponding to a particular address of the means for caching data is not stored in the means for caching data but is available from at least one of multiple sources external to the means for caching data and wherein at least one of the multiple sources is a store buffer.

23. The apparatus of claim 22, further comprising:
means for performing an address compare to determine at least one state based on the state information stored in the means for storing state information; and
means for selectively retrieving data from the store buffer based at least in part on a determination that the at least one state is the state that indicates that updated data corresponding to the particular address of the means for caching data is not stored in the means for caching data.

24. A non-transitory computer-readable medium including program code that, when executed by a processor, causes the processor to:
store state information at a state array of a cache memory, wherein the state information includes a state that indicates updated data corresponding to a particular address of the cache memory is not stored in the cache memory but is available from at least one of multiple sources external to the cache memory and wherein at least one of the multiple sources is a store buffer.

25. The non-transitory computer-readable medium of claim 24, further including program code that, when executed by the processor, causes the processor to:
perform an address compare to determine at least one state based on the state information stored in the state array; and
selectively retrieve data from the sore buffer based at least in part on a determination that the at least one state is the state that indicates that updated data corresponding to the particular address of the cache memory is not stored in the cache memory.
